(19) United States
(12) Patent Application Publication
(10) Pub. No.: US 2005/0157226 A1
(43) Pub. Date: Jul. 21, 2005

(54) Integrated color filter and fabricating method thereof

(76) Inventor: Chih-Chieh Lan, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/867,117

(22) Filed: Jun. 14, 2004

(30) Foreign Application Priority Data
Jan. 16, 2004 (TW) 93101151

(51) Int. Cl. G02F 1/1335; G02F 1/136

(52) U.S. Cl. 349/106; 349/42

(57) ABSTRACT

An integrated color filter comprising a glass substrate; an active matrix, including a plurality of switching elements, formed on the glass substrate; a plurality of color-filter units formed on the active matrix; a plurality of pixel electrodes formed on the color-filter units and electrically connected to the switching elements; and a transparent planarization layer formed on the pixel electrodes. Electrical testing can be performed immediately after completion of the pixel electrodes, such that, if defects are found, the panel can be first discarded, eliminating production time for a transparent planarization layer on the discarded panel and costs thereof.

### BACKGROUND OF THE INVENTION

1. Field of the Invention

The present invention relates to an integrated color filter, and more particularly to an integrated color filter, in which pixel electrodes are formed before a transparent planarization layer.

2. Description of the Related Art

FIG. 1 is a cross-section of a conventional LCD (liquid crystal display). Liquid crystal 90 is interposed between glass substrates 10 and 10′. Color-filter units 41 and an active matrix 20 (including a gate insulating layer 22, data lines DL, pixel electrodes 25, and a passivation layer 26) are respectively formed on glass substrates 10′ and 10. In the manufacturing process, color-filter units 41 are formed on the glass substrate 10′, and a gate insulating layer 22, data lines DL, pixel electrodes 25, and a passivation layer 26 are formed on the glass substrate 10. Next, the two substrates 10 and 10′ are aligned and joined with a gap therebetween, and liquid crystal 90 is filled into the gap. During manufacture, precise alignment must be maintained, and a specific gap must be preserved, otherwise yield rate is compromised.

To improve the above disadvantage, many techniques involving an integrated color filter (ICF) have been developed, which form the color filter, black matrix, and active matrix on the same glass substrate, thus avoiding the requirements for strict alignment. The color filter on array (COA) process is an example. FIG. 2 is a cross-section of a COA-type LCD. An active matrix 20 manufacturing process is performed first on a glass substrate 10. Then, a color filter manufacturing process is directly performed on the same substrate, forming red, green, and blue color-filter units 41. By integrating the color filter and active matrix manufacturing processes, possible light leakage resulting from misalignment is avoided, and aperture ratio and brightness are increased.

Conventional COA technique uses conventional color-filter units and a transparent planarization layer (over coat) covered thereon. Related disclosure can be referred to U.S. Pat. No. 5,818,550, U.S. Pat. No. 6,031,512, SID2000 42.4, and SID2000 48.2. The fabrication sequence first forms conventional color-filter units and then a transparent planarization layer. Pixel electrodes are finally defined. The transparent planarization layer is an expensive material. After completion of pixel electrodes, electrical testing can be performed. At this time, if defects are found and the panel must be discarded, it is a waste of material and costs.

### SUMMARY OF THE INVENTION

An object of the present invention is to solve the above-mentioned problem and provide an integrated color filter. The present invention forms pixel electrodes before forming a transparent planarization layer. After completion of pixel electrodes, electrical testing can be performed. The present invention's capability to perform electrical testing after formation of pixel electrodes but before the transparent planarization layer, allows, if defects are found, the panel to be discarded first. Thus, there is no need to produce a transparent planarization layer for the discarded panel, such that production time of a transparent planarization layer on the defective panel is eliminated, and material costs for the transparent planarization layer are also saved.

Another object of the present invention is to provide a liquid crystal display comprising the integrated color filter of the present invention. The transparent planarization layer can block impurities in color-filter units from contaminating liquid crystal. Moreover, the transparent planarization layer also serves as a protective layer, such that the polyimide (PI) rubbing process at the back end will not rub the pixel electrodes, causing defects. Moreover, the transparent planarization layer also provides planarization effect and reduces poor orientation due to topographical profile on the glass substrate.

To achieve the above objects, the integrated color filter of the present invention comprises a glass substrate; an active matrix, including a plurality of switching elements, formed on the glass substrate; a plurality of color-filter units formed on the active matrix; a plurality of pixel electrodes formed on the color-filter units and electrically connected to the switching elements; and a transparent planarization layer formed on the pixel electrodes. The switching elements can be thin film transistors (TFT). The transparent planarization layer can be an organic resin material, such as polycarbonate, acrylic resin, or benzocyclobutene (BCB), having a transmmitivity higher than 90% and a dielectric constant of 2.6 to 3.6.

The method for fabricating the integrated color filter of the present invention includes the following steps. A glass substrate is provided. An active matrix, including a plurality of switching elements, is formed on the glass substrate. A plurality of color-filter units are formed on the active matrix. A plurality of pixel electrodes are formed on the color-filter units to electrically connect the switching elements. Finally, a transparent planarization layer is formed on the pixel electrodes. The transparent planarization layer is formed after the pixel electrodes are formed.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a cross-section of a conventional LCD (liquid crystal display).

FIG. 2 is a cross-section of a conventional color filter on array-type LCD.

FIG. 3 is a top view of a portion of an integrated color filter according to a first embodiment of the present invention.

FIG. 4 is a cross-section taken along line 4-4 of FIG. 3.

FIG. 5 is a cross-section of a color liquid crystal display of the present invention.

FIG. 6 is a top view of a portion of an integrated color filter according to a second embodiment of the present invention.

FIG. 7 is a cross-section taken along line 7-7 of FIG. 6.

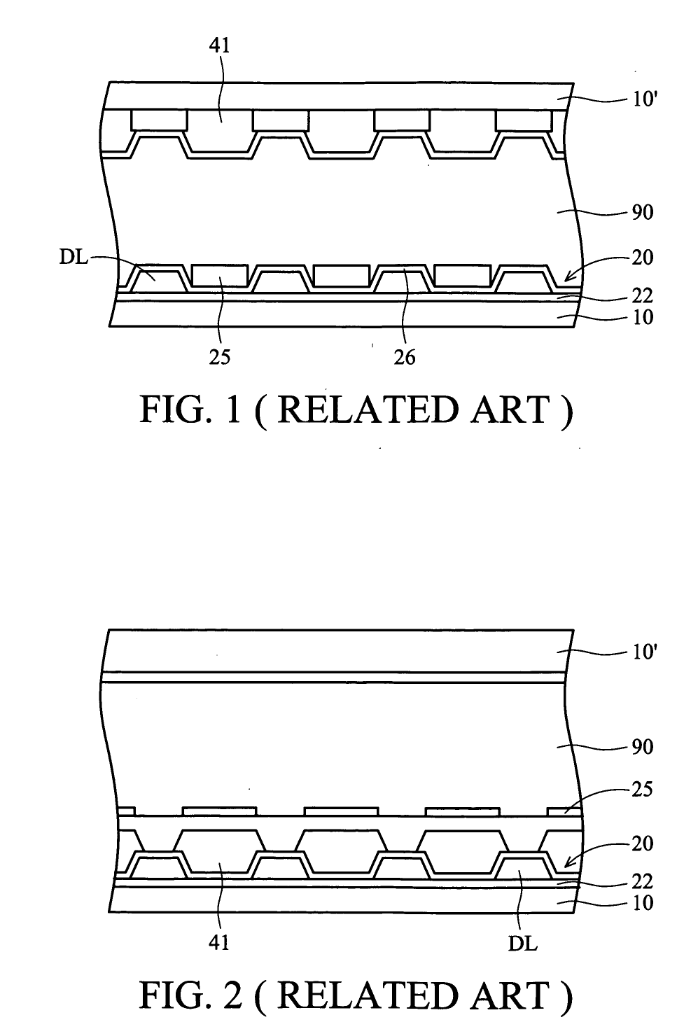

### DETAILED DESCRIPTION OF THE INVENTION

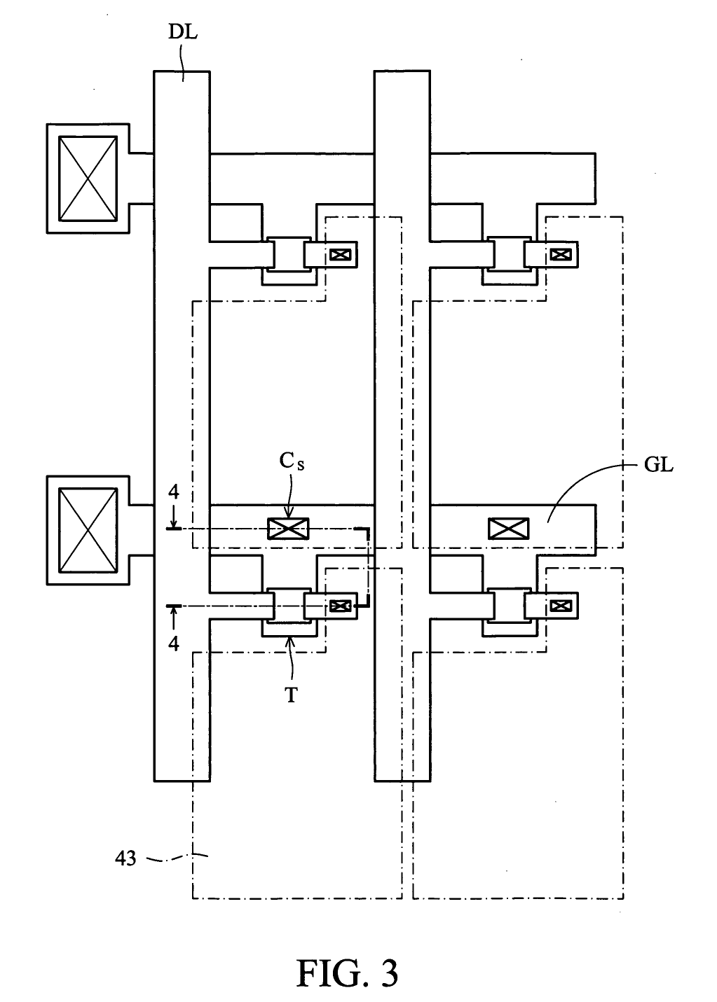

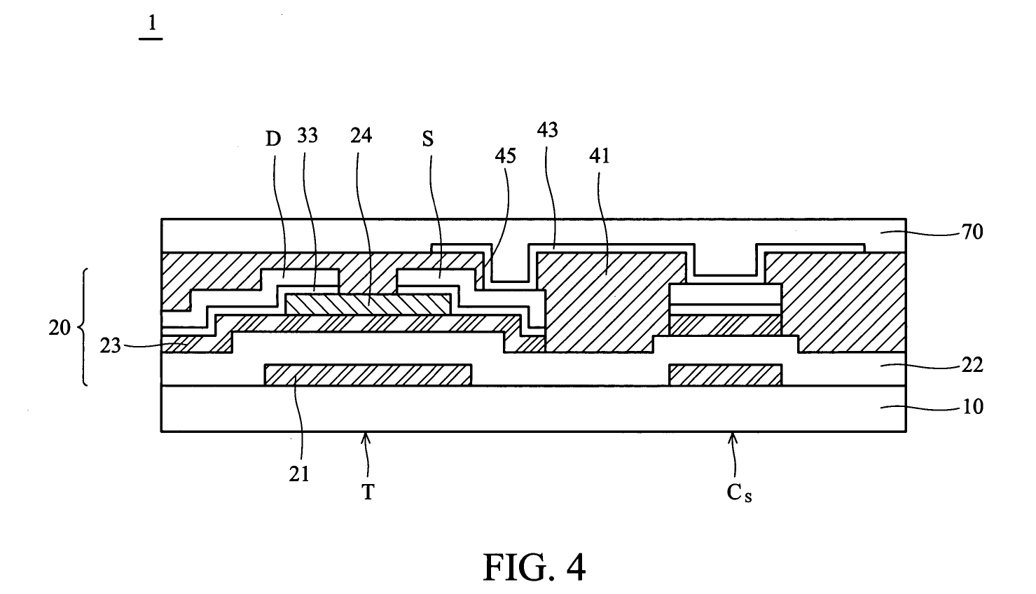

FIG. 3 is a top view of a portion of an integrated color filter according to a first embodiment of the present invention. FIG. 4 is a cross-section taken along line 4-4 of FIG. 3. Referring to FIG. 3, the integrated color filter includes a plurality of data lines (DL) extending along a longitudinal direction, a plurality of gate lines (GL) or scanning lines extending along a transversal direction, a plurality of switching elements T and storage capacitors (Cs) disposed adjacent to the intersection of data lines (DL) and gate lines (GL), and a plurality of pixel electrodes 43 in pixel regions defined by the data lines (DL) and gate lines (GL), arranged in a matrix.

Referring to FIG. 4, the integrated color filter 1 includes a glass substrate 10, an active matrix 20 with a plurality of switching elements T, formed on the glass substrate 10, a plurality of color-filter units 41 formed on the active matrix 20, a plurality of pixel electrodes 43 formed on the color-filter units 41 and electrically connected to the switching elements T, and a transparent planarization layer 70 formed on the pixel electrodes 43.

The switching elements suitable for use in the present invention are not limited, for example, to a thin film transistor (TFT), particularly a bottom-gate type TFT. In the above first embodiment, the switching elements are belonged to a bottom-gate type TFT. Also, the TFT comprises an etching stop structure. Referring to FIG. 4, each etching stop thin film transistor (ES TFT) of the active matrix 20 comprises a gate 21, a gate insulating layer 22, an active layer 23, an etching stop layer 24, an ohmic contact layer 33, a source electrode S, and a drain electrode D. The active layer 23 can be an amorphous silicon layer formed by plasma-enhanced chemical vapor deposition (PECVD) or low pressure chemical vapor deposition (LPCVD) using silane (SiH₄) as reactant gas. The active layer 23 can also be a polysilicon layer formed by first forming an amorphous layer and then performing excimer laser annealing (ELA) at low temperature to form the polysilicon layer. The ohmic contact layer 33 can be an n⁺ type doped amorphous silicon layer formed by chemical vapor deposition (CVD) using silane (SiH₄) and PH₃ as reactant gases.

Still referring to FIG. 4, after fabrication of switching elements T is complete (also completing storage capacitors (Cs)), color-filter units 41 are formed on the glass substrate 10 in a predetermined position. A color resist material, that is, an organic photosensitive material containing pigment, is coated over the entire surface of the glass substrate 10 by spin coating. Then, exposure, development, and baking are performed to form color-filter units 41 having a dielectric constant of 3.2 to 3.8 preferably. The color-filter units 41 have contact openings 45 in a corresponding position of the source electrodes S.

Subsequently, a plurality of pixel electrodes 43 are formed on the color-filter units 41 to extend to the contact openings 45 to electrically connect the source electrodes S. For example, an indium tin oxide (ITO) layer can be deposited by sputtering to fill the contact openings 45 and electrically contact the source electrodes S of the switching elements T at the bottom.

Subsequently, a transparent planarization layer 70 is formed on the pixel electrodes 43 by, for example, spin coating to a thickness of 1.0 to 3.0 μm. The transparent planarization layer 70 can be an organic resin material such as polycarbonate, acrylic resin, or benzocyclobutene (BCB).

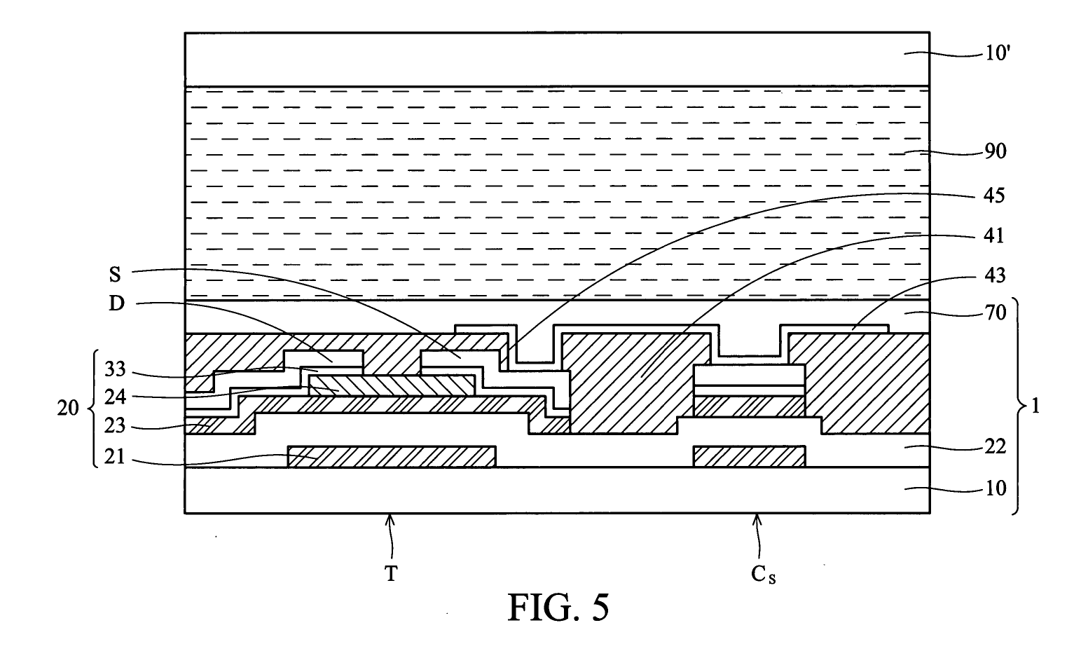

Subsequently, still referring to FIG. 4, an orientation film (not shown) is formed on the transparent planarization layer 70 and then rubbed to constitute an integrated color filter 1. Next, referring to FIG. 5, another glass substrate 10′ is provided, on whose inner surface a common electrode and another orientation film (not shown) may be disposed. Finally, liquid crystal 90 is filled into the space between the glass substrates 10 and 10′, thus completing the color liquid crystal display of the present invention.

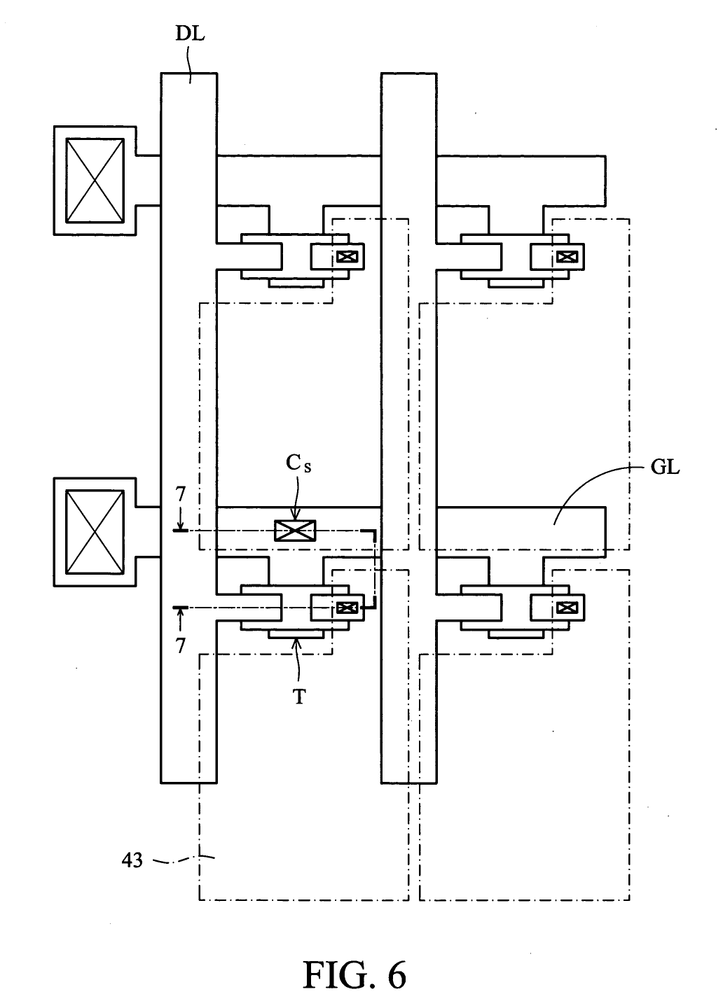

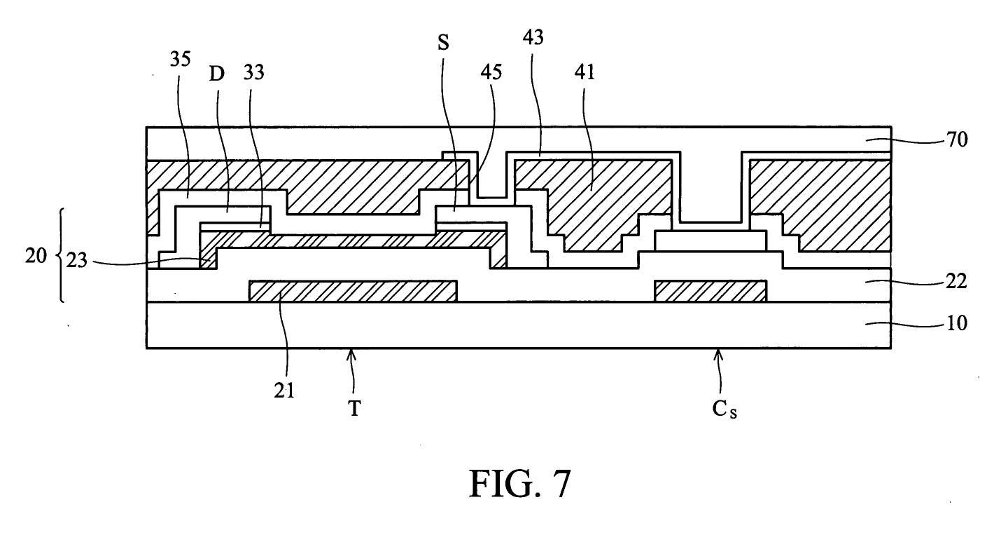

FIG. 6 is a top view of a portion of an integrated color filter according to a second embodiment of the present invention. FIG. 7 is a cross-section taken along line 7-7 of FIG. 6. Referring to FIG. 6, the integrated color filter includes a plurality of data lines (DL) extending along a longitudinal direction, a plurality of gate lines (GL) or scanning lines extending along a transversal direction, a plurality of switching elements T and storage capacitors (Cs) disposed adjacent to the intersection of data lines (DL) and gate lines (GL), and a plurality of pixel electrodes 43 in pixel regions defined by the data lines (DL) and gate lines (GL), arranged in a matrix.

The integrated color filter of the second embodiment is similar to the first embodiment, except that the switching elements T used in the second embodiment are of back channel etching structure (BCE structure), unlike the first embodiment. Referring to FIG. 7, each back channel etching type TFT of the active matrix 20 comprises a gate 21, a gate insulating layer 22, an active layer 23, an ohmic contact layer 33, a source electrode S, and a drain electrode D. The active layer 23 can be an amorphous silicon layer formed by plasma-enhanced chemical vapor deposition (PECVD) or low pressure chemical vapor deposition (LPCVD) using silane (SiH₄) as reactant gas. The active layer 23 can also be a polysilicon layer formed by first forming an amorphous layer and then performing excimer laser annealing (ELA) at low temperature to form the polysilicon layer. The ohmic contact layer 33 can be an n⁺ type doped amorphous silicon layer formed by chemical vapor deposition (CVD) using silane (SiH₄) and PH₃ as reactant gases. The switching elements T may further include a passivation layer 35 formed thereon. The passivation layer 35 can be a silicon nitride layer.

Still referring to FIG. 7, after fabrication of switching elements T is complete (also completing storage capacitors (Cs)), color-filter units 41 are formed on the glass substrate 10 in a predetermined position. A color resist material, that is, an organic photosensitive material containing pigment, is coated over the entire surface of the glass substrate 10 by spin coating. Then, exposure, development, and baking are performed to form color-filter units 41 having a dielectric constant of 3.2 to 3.8 preferably. The color-filter units 41 have contact openings 45 in a corresponding position of the source electrodes S.

Subsequently, a plurality of pixel electrodes 43 are formed on the color-filter units 41 to extend to the contact openings 45 to electrically connect the source electrodes S. For example, an indium tin oxide (ITO) layer is deposited by sputtering to fill the contact openings 45 and electrically contact the source electrodes S of the switching elements T at the bottom.

The main feature of the present invention resides in the formation sequence of the color-filter units 41, pixel electrodes 43, and transparent planarization layer 70. Compared to the conventional integrated color filter, in the present invention, the pixel electrodes 43 are formed first, and then the transparent planarization layer 70 is formed. Therefore, the present invention has the following advantages.

After completion of pixel electrodes but before formation of transparent planarization layer, electrical test can be performed. If defects are found, the panel can be first discarded. Therefore, there is no need to produce a transparent planarization layer for the discarded panel. Thus, production time of the transparent planarization layer for the discarded panel is saved, as are costs thereof.

The transparent planarization layer 70 blocks impurities in color-filter units 41 from contaminating the liquid crystal.

The transparent planarization layer 70 also serves as a protective layer, such that the polyimide rubbing process at the back end will not rub the pixel electrodes to cause defect. In contrast, in the conventional process, since the transparent planarization layer is below the pixel electrodes, pixel electrodes are rubbed easily, causing defects.

The transparent planarization layer 70 also provides planarization effect and reduces poor orientation due to topographical profile on the glass substrate.

The foregoing description of the preferred embodiments of this invention has been presented for purposes of illustration and description. Obvious modifications or variations are possible in light of the above teaching. The embodiments chosen and described provide an excellent illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

1. An integrated color filter, comprising:
a glass substrate;
an active matrix, including a plurality of switching elements, formed on the substrate;
a plurality of color-filter units formed on the active matrix;
a plurality of pixel electrodes formed on the color-filter units and electrically connected to the switching elements; and
a transparent planarization layer formed on the pixel electrodes.

2. The integrated color filter as claimed in claim 1, wherein the color-filter units have a dielectric constant of about 3.2 to 3.8.

3. The integrated color filter as claimed in claim 1, wherein the switching elements are bottom-gate type thin film transistors.

4. The integrated color filter as claimed in claim 3, wherein the bottom-gate type thin film transistors are of an etching stop type.

5. The integrated color filter as claimed in claim 3, wherein the bottom-gate type thin film transistors are of a back channel etching type.

6. The integrated color filter as claimed in claim 1, wherein the color-filter units are formed on the glass substrate and the switching elements and comprise contact openings for electrical contact between the pixel electrodes and the switching elements.

7. The integrated color filter as claimed in claim 1, wherein the transparent planarization layer comprises organic resin.

8. The integrated color filter as claimed in claim 1, wherein the transparent planarization layer comprises polycarbonate, acrylic resin, or benzocyclobutene (BCB).

9. The integrated color filter as claimed in claim 1, wherein the transparent planarization layer has a transmittivity higher than 90%.

10. The integrated color filter as claimed in claim 1, wherein the transparent planarization layer has a dielectric constant of about 2.6 to 3.6.

11. A color liquid crystal display, comprising:
a first substrate;
an active matrix, including a plurality of switching elements, formed on the first substrate;
a plurality of color-filter units formed on the active matrix;
a plurality of pixel electrodes formed on the color-filter units, electrically connected to the switching elements;
a transparent planarization layer formed on the pixel electrodes;
a second substrate; and
liquid crystal interposed between the first substrate and the second substrate.

12. The color liquid crystal display as claimed in claim 11, wherein the color-filter units have a dielectric constant of about 3.2 to 3.8.

13. The color liquid crystal display as claimed in claim 11, wherein the switching elements are bottom-gate type thin film transistors.

14. The color liquid crystal display as claimed in claim 13, wherein the bottom-gate type thin film transistors are of an etching stop type.

15. The color liquid crystal display as claimed in claim 13, wherein the bottom-gate type thin film transistors are of a back channel etching type.

16. The color liquid crystal display as claimed in claim 11, wherein the color-filter units are formed on the glass substrate and the switching elements and have contact openings for electrical contact between the pixel electrodes and the switching elements.

17. The color liquid crystal display as claimed in claim 11, wherein the transparent planarization layer comprises organic resin.

18. The color liquid crystal display as claimed in claim 11, wherein the transparent planarization layer comprises polycarbonate, acrylic resin, or benzocyclobutene (BCB).

19. The color liquid crystal display as claimed in claim 11, wherein the transparent planarization layer has a transmittivity higher than 90%.

20. The color liquid crystal display as claimed in claim 11, wherein the transparent planarization layer has a dielectric constant of about 2.6 to 3.6.
